(19) United States
(12) Patent Application Publication
(10) Pub. No.: US 2025/0253922 A1
(43) Pub. Date: Aug. 7, 2025

(54) METHOD AND APPARATUS FOR BEAM FAILURE RECOVERY IN MIMO SYSTEMS

(71) Applicant: INTERDIGITAL PATENT HOLDINGS, INC., Wilmington, DE (US)

(72) Inventors: Kyle Jung-Lin PAN, Saint James, NY (US); Guodong Zhang, Woodbury, NY (US); Arman Shojaeifard, London (GB); Allan Yingming Tsai, Boonton, NJ (US); Ahmet Serdar Tan, London (GB); Patrick Svedman, Stockholm (SE)

(73) Assignee: INTERDIGITAL PATENT HOLDINGS, INC., Wilmington, DE (US)

(21) Appl. No.: 18/854,880

(22) PCT Filed: Apr. 7, 2023
(86) PCT No.: PCT/US2023/017850

§ 371 Date: Oct. 7, 2024

Related U.S. Application Data
(60) Provisional application No. 63/329,229, filed on Apr. 8, 2022.

(51) Int. Cl. H04B 7/06; H04W 72/232; H04W 74/0833

(52) U.S. Cl. CPC H04B 7/06964; H04W 72/232; H04W 74/0833

(57) ABSTRACT

A method and apparatus for beam failure recovery are described herein. A method may include receiving configuration information including parameters for beam failure recovery, determining, based on the configuration information, whether to perform a regular beam failure detection or a partial beam failure detection, and monitoring, based on the determination, a plurality of beam failure detection reference signals (BFD-RSs). A method may further include transmitting, based on the monitored BFD-RSs, at least one message, receiving a response to the transmitted at least one message, and determining, based on the received response, that beam failure recovery is complete. The at least one message may be at least one of a beam failure recovery request, a beam switch request, or a beam switch recommendation. The plurality of BFD-RSs may include a greater number of BFD-RSs when regular beam failure detection is performed than when partial beam failure detection is performed.

### CROSS-REFERENCE TO RELATED APPLICATIONS

This application claims the benefit of U.S. Provisional Application No. 63/329,229, filed Apr. 8, 2022, the contents of each are incorporated herein by reference.

### BACKGROUND

Multiple input-multiple output (MIMO) methods may have an impact on beam failure recovery (BFR) procedures. Deployment of MIMO systems (e.g., massively-distributed MIMO, cell-free MIMO, or user-centric MIMO) can be used to enhance beam quality, mitigate beam failure and increase opportunities of beam failure recovery. However, such technology may also increase system overhead and complexity/power as well as latency. As the number of transmit/receive points (TRPs) increases, beam failure detection reference signal (BFD-RS) resources (i.e., q0) increase, as do new beam identification (NBI)-RSs) resources (i.e., q1). A wireless transmit/receive unit (WTRU) may need to monitor a larger q0 set, i.e., more BFD-RS sets as well as large q1 sets (NBI-RS set). In addition, greater signaling and RS overhead as well as latency and performance may be expected for monitoring, measurements, BFR request and corresponding network (NW) response transmission and reception.

### SUMMARY

A method and apparatus for beam failure recovery are described herein. A method may include receiving configuration information including parameters for beam failure recovery, determining, based on the configuration information, whether to perform a regular beam failure detection or a partial beam failure detection, and monitoring, based on the determination, a plurality of beam failure detection reference signals (BFD-RSs). A method may further include transmitting, based on the monitored BFD-RSs, at least one message, receiving a response to the transmitted at least one message, and determining, based on the received response, that beam failure recovery is complete. The at least one message may be at least one of a beam failure recovery request, a beam switch request, or a beam switch recommendation. The plurality of BFD-RSs may include a greater number of BFD-RSs when regular beam failure detection is performed than when partial beam failure detection is performed.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 illustrates an example method of an adaptive q0 mechanism;

FIG. 3 illustrates an method of partial beam failure detection;

FIG. 4 is an illustration of an exemplary design for priority-based beam failure detection;

FIG. 5 illustrates an example of a WTRU procedure for BFR with assistance information;

FIG. 6 illustrates an example method of a BFR-based random access procedure with an implicit indication;

FIG. 7 illustrates an example of a two-stage beam failure recovery request (BFRQ) management procedure;

FIG. 8 illustrates examples of a two-stage BFRQ management procedure with maximum number of re-transmissions;

FIG. 9 illustrates an example method for adaptive BFRQ;

FIG. 10 illustrates an example method by which a network (NW) may respond to a BFRQ;

FIG. 11 illustrates an example method of WTRU-controlled beam failure recovery;

FIG. 12 illustrates an example procedure of WTRU-controlled beam failure recovery; and

FIG. 13 illustrates an example method of beam failure recovery procedure for MIMO (e.g., massively-distributed MIMO, cell-free MIMO, or user-centric MIMO).

### DETAILED DESCRIPTION

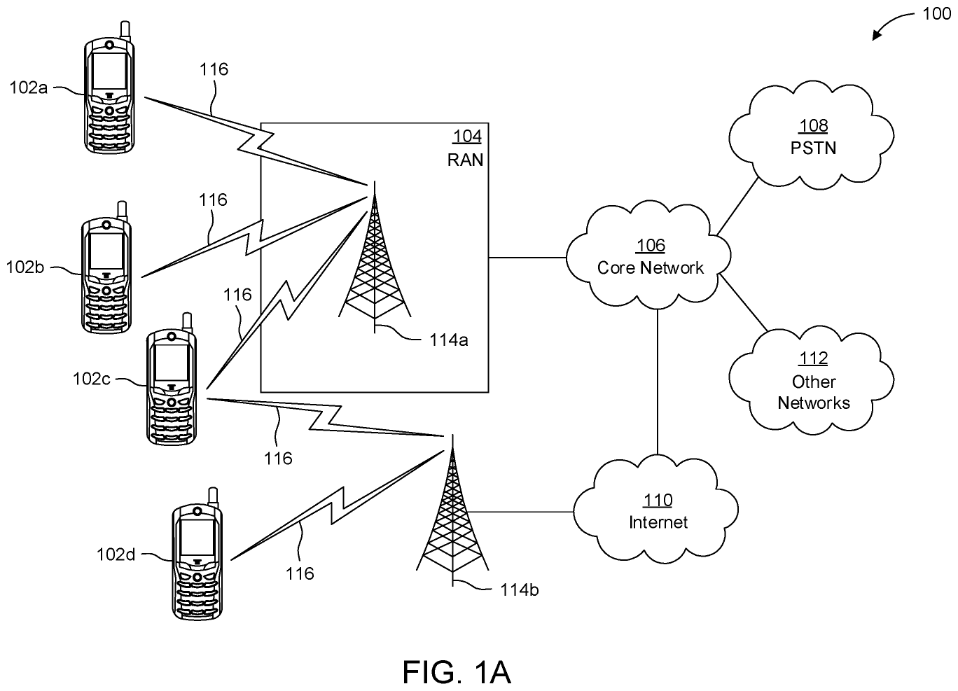

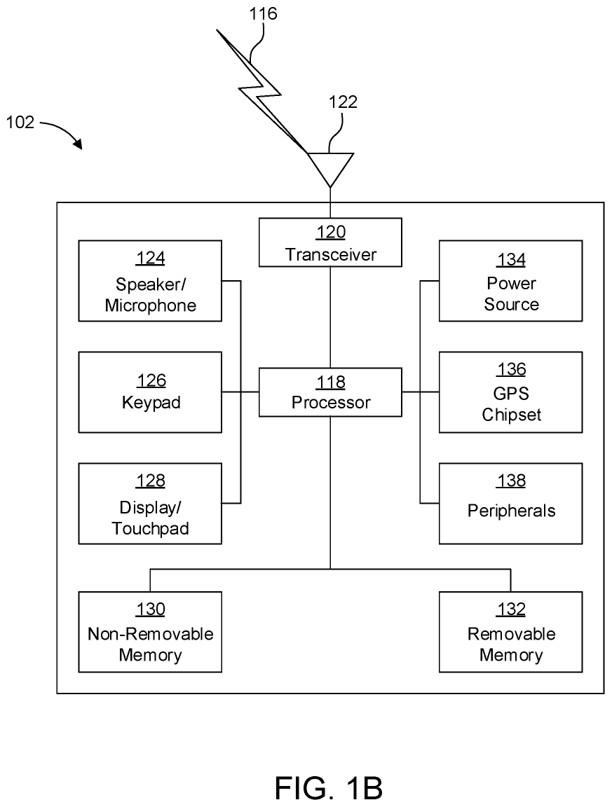

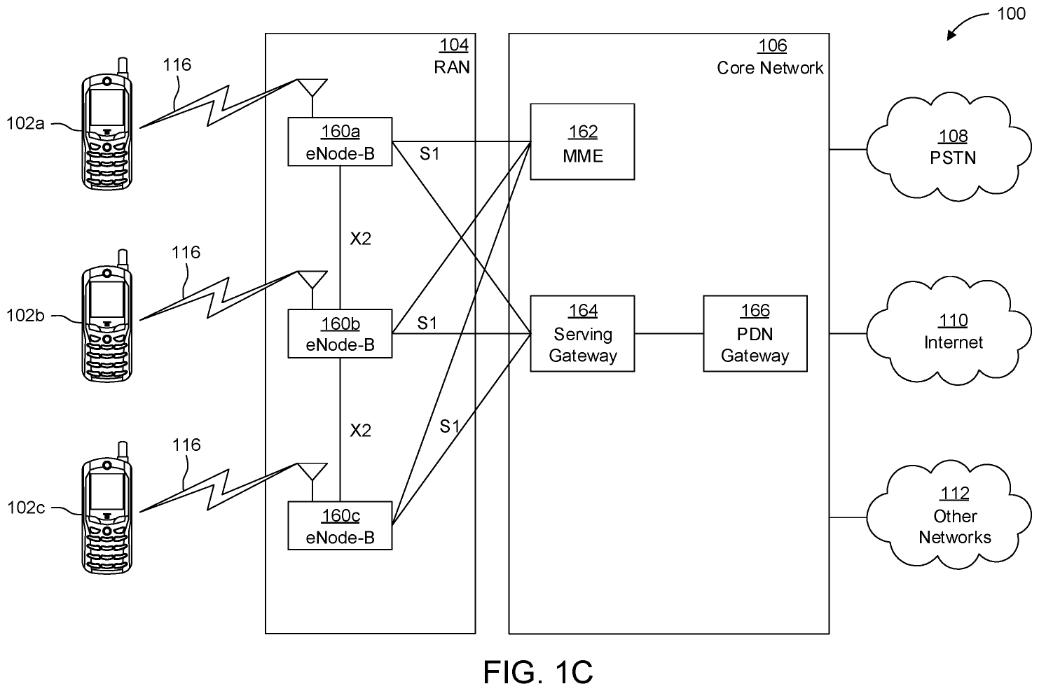

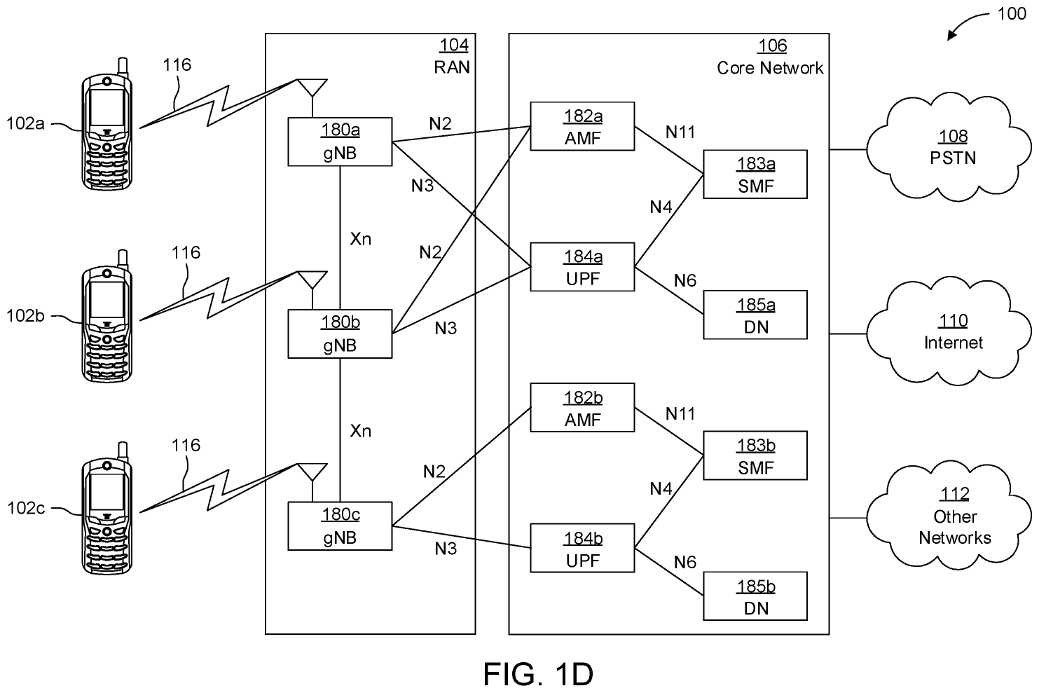

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (base station), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) PacketAccess (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11 ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a,184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Various methods of beam failure detection for MIMO (e.g., massively-distributed MIMO, cell-free MIMO, or user-centric MIMO) systems are proposed. Adaptive BFR-RS mechanisms and solutions are proposed. Methods of partial beam failure detection are proposed for MIMO. Partial beam failure detection may be used to reduce latency and delay as well as reduce system complexity for MIMO based BFR. Methods of priority-based beam failure detection are proposed to be used for MIMO systems.

Methods of new beam identification for MIMO are proposed. Methods of BFR assistance information and RACH type with implicit indication are proposed for MIMO.

Methods of beam failure recovery request for MIMO are proposed. Methods of flexible beam failure recovery (BFR) management are proposed for enabling operation flexibility and performance for MIMO. BFRQ reliability enhancements and diversity transmission are proposed for MIMO.

Methods of network response to BFRQ are proposed for MIMO. Methods of WTRU-controlled beam failure recovery are proposed for MIMO systems. Methods for WTRU controlled BFR with beam failure recovery order are proposed. Event-triggers and/or condition-based BFR may be used. Based on certain criteria and condition(s), a new set of NBI-RS resources may be triggered, and a WTRU may switch to measure the new set of NBI-RS resource set from the original set of NBI-RS resources. This may be used to prevent the WTRU from not finding any qualified NBI-RS resource and enter to contention-based random access procedure which may have large latency and long delay.

In fifth generation (5G) New Radio (NR) systems, a beam failure recovery procedure may include one or more stages. At least four examples of such stages of a beam failure recovery procedure may be described as follows: Stage 1: beam failure detection; Stage 2: new beam identification; Stage 3: beam failure recovery request; and Stage 4: NW response.

Stage 1, which refers to beam failure detection, may be described as follows. Beam failure detection may be a combined layer 1 (L1) or layer 2 (L2) procedure where L1 (i.e., referring to a layer 1 entity, or hardware (e.g., a processor and a transceiver) configured to detect, process, or transmit layer 1 signals, or another logically equivalent layer, provides the medium access control (MAC) layer with indications of beam failure instances (BFIs). The network may configure a set of resources and reference signals for the WTRU to monitor the radio link quality. The configured BFD resources signals may be channel state information reference signals (CSI-RSs) or synchronization signal blocks (SSBs). When the physical (PHY) layer detects that the signal to interference noise ratio (SINR) of the Reference signal of the serving beam goes below the threshold, i.e. 10% block error rate (BLER) of a hypothetical physical downlink control channel (PDCCH), it may trigger a beam failure instance, or may cause the WTRU to recognize a beam failure instance, and send a message to the MAC layer or another logical equivalent. The MAC layer may count the indications and declare failure when a configured maximum number of beam failure indications (BFIs) has been reached.

Beam failure may be triggered based on, for example, the passage of a given time duration, or a given number of beam failure instances. The WTRU (e.g., at the MAC layer) may store timing information related to the BFI. For instance, the WTRU may measure a time duration starting the when the WTRU receives a BFI. Alternatively, or additionally, the WTRU may store timing information in the form of a counter, which may be incremented, for example, by one for every further received BFI. When a certain number of BFIs are observed, for example, such that the number passes a threshold (e.g., a configured or preconfigured maximum number of BFIs) within a given time window (e.g., a configured or preconfigured time window duration), the WTRU may determine (e.g., at the MAC layer) that beam failure has occurred and begin a recovery procedure.

Stage 2, which refers to new beam identification, may be described as follows. After beam failure is detected, the WTRU may need to search and find a new beam. A base station may configure a set of reference signals, e.g., a CSI-RS resource, i.e., NBI-RS (or q1). The WTRU may measure a reference signal and find a suitable beam according to one or more criteria, which may be, for example, the beam with the strongest L1-reference signal received power (RSRP), the beam with L1-RSRP that is greater than a predefined or configured threshold, or a beam that is determined to be a “best” beam according to other criteria. If a suitable new beam is found that meets the above-referenced criteria, the WTRU may send a beam failure recovery request (BFRQ). If a suitable new beam is not found, the WTRU may initiate a contention-based 4-step random access for the purpose of BFR.

Stage 3, which refers to the sending of BFRQs, may be described as follows. Upon detecting beam failure, a WTRU may initiate a random access procedure for beam failure recovery purposes for an SpCell. According to, for example, the RRC information element of BeamFailureRecoveryConfig, the random access process may be contention-based or contention-free. In the random access procedure, the WTRU may transmit a BFRQ to the base station/TRP.

Stage 4, which may refer to the sending and/or reception of a NW response, may be described as follows. To receive a response to the BFRQ transmitted in RACH, the WTRU may monitor for a random-access response (RAR) scrambled by a RA-radio network temporary identifier (RNTI) (i.e., in a contention-based case) or cell-specific RNTI (C-RNTI) (i.e., in a contention free case) in a control resource set (CORESET) configured for BFR. Such a CORESET may be configured, for example, by the RRC information element of recoverySearchSpaceId for the SpCell. The WTRU may retransmit a BFRQ until either a maximum number of BFRQ retransmissions is reached or the BFR random access procedure is completed successfully. Upon successful completion of the RACH, the beam failure recovery procedure may be completed.

Various problems prompting the solutions proposed herein are described.

Beam failure recovery procedures may be supported in Release 15 and/or 16 technical specifications for use with a single TRP. Beam failure recovery procedures may be supported in Release 17 technical specifications with up to two TRPs. TRP-specific beam failure recovery procedure may be supported in Release 17 technical specifications.

MIMO may have an impact on beam failure recovery procedures. The deployment of MIMO technologies could be used to enhance beam quality, mitigate beam failure and increase opportunities for beam failure recovery. However, it may also increase system overhead and complexity/power as well as latency. As the number of TRPs increases, BFD-RS resources (i.e., q0) increase, as do NBI-RS resources (i.e., q1). A WTRU may need to monitor more BFD-RS sets (i.e., a larger q0 set) as well as more NBI-RS sets (i.e., a large q1 set). In addition, high signaling and RS overhead as well as latency and performance may be expected for monitoring, measurements, BFR request and corresponding NW response transmission and/or reception when MIMO is deployed.

q0 may be large due to the deployment of a MIMO system. A WTRU may be configured with up to three CORESETs in the case of single TRP. A WTRU may be required to monitor periodic CSI-RS resources that are quasi co-located (QCL-ed) with CORESETs. A WTRU may be configured with up to 5 CORESETs in case of 2 TRPs. However, the more the TRPs, the higher the number of CORESETs and BFD-RS resources (e.g., CSI-RS resources) may be required to be monitored for MIMO systems. Beam failure recovery procedures may need to be extended to cover scenarios with very large numbers of TRPs in the case of MIMO deployments. One problem raised in these scenarios may be how to enhance BFR with low overhead and low complexity/power design. Another problem may be how to enable fast BFR and manage beams quickly with low latency and delay. Yet another problem may be how to enhance reliability and performance for BFR. Yet another problem may be how to ensure a WTRU may continue and complete a BFR procedure even if a channel condition deteriorates during the BFR procedure.

Various solutions to the above problems are described herein. In some solutions, methods of beam failure detection for MIMO may be provided.

Adaptive BFD-RS sets, sizes and periodicities are aspects of potential solutions. In the following paragraphs, methods of beam failure detection for MIMO are considered. As described substantially in paragraphs above, a WTRU may monitor a BFD-RS set (also referred to herein as “q0” or a “q0 set”). q0 may be large due to the deployment of a MIMO system. The more TRPs that are used, the higher number of BFD-RS resources (e.g., CSI-RS resources) that may be required to be monitored.

If the size of q0 is limited to a small set, then the system may not fully take advantage of a massive TRP deployment. For example, frequent beam failure may occur and may be detected. On the other hand, if a large q0 set is used, then large overhead may occur. In addition, high complexity and power may be introduced as well.

Adaptive mechanisms for q0 may be utilized to reduce complexity, overhead, and power as well as to enhance reliability, improve accuracy and higher performance. An adaptive q0 set may be used. In addition, an adaptive q0 size may also be utilized. In certain conditions, e.g., beam quality may above a predefined or (pre-)configured threshold, a small BFD-RS resource set for q0 may be used. If beam failure is detected, a WTRU may need to perform one or more beam failure recovery procedures. In other conditions, e.g., when beam quality is below a predefined or (pre-)configured threshold, a large BFD-RS resource set for q0 may be used to avoid entering to beam failure recovery procedure at the cost of higher overhead and power since a WTRU may need to monitor and measure much larger RS resource sets, e.g., NBI-RS resource set. To balance the performance and overhead, an adaptive q0 size may be utilized. In addition, different periodicities and sets may also be used.

If q0 does not have good quality, then beam failure may be detected. Different q0 sets and/or different q0 sizes may be utilized. A WTRU may switch between BFD-RS set q0 of different sizes to balance performance, overhead and power. A set switch or size switch may be triggered based on certain criteria and conditions, e.g., number and/or ratio of BFDs, number and/or ratio of NBIs, number and/or ratio of BFRQs, etc. may be considered and used for making the decision to switch during q0 adaptation. A switch may also be triggered based on measurements such as L1-RSRP, L1-SINR, etc. In addition, a switch may also be triggered based on requirements, service types, QoS, etc. Furthermore, a switch may also be triggered based on a number of BFIs.

To reduce overhead and power, two or more different periodicities may be introduced e.g., for different q0 sets. One periodicity may be used for and associated with a large q0 set and another periodicity may be used for and associated with small q0 set. For example, a large periodicity may be used for and associated with a large q0 set and a small periodicity may be used for and associated with a small q0 set to reduce overhead, etc. By doing so, a WTRU may monitor large q0 set less frequently due to longer periodicity and monitor small q0 set more frequently due to shorter periodicity.

To reduce complexity, different measurement metrics may be used for different q0 sets. A hypothetical PDCCH BLER or L1-SINR may be used for measurement metrics. Hypothetical PDCCH BLER or L1-SINR measurement metrics may be more accurate but may also have high complexity. On the other hand, an L1-RSRP measurement metric may be simple but may have less accuracy. If different measurement metrics are used for different q0 sets, complexity may be reduced, power consumption may also be lower, and there may be some trade-off between performance, complexity, power and overhead. For different q0 sets, one measurement metric may be used for and associated with q0 set 1 (i.e., a “first” q0 set) and another measurement metric may be used for and associated with q0 set 2 (i.e., a “second” q0 set). For different q0 sets or sizes, one measurement metric may be used for and associated with q0 size 1 and another measurement metric may be used for and associated with q0 size 2. For example, a PDCCH BLER or L1-SINR may be used for and associated with a small q0 set while L1-RSRP may be used for and associated with large q0 set, and so on.

A set-dependent and/or size-dependent measurement metric may be utilized. When a WTRU monitors a larger q0 set, an L1-RSRP may be used for quick screening. Quick screen may be a simple measurement using measured received power such as L1-RSRP measurement or the like. This could reduce complexity and enable power saving. When it is reduced to a smaller q0 set, a WTRU may switch to a hypothetical PDCCH BLER L1-SINR for reliability enhancement and achieve better accuracy. Pre-defined or (pre-)configured hopping patterns and/or rules between q0 sets and/or sizes may also be used. WTRU may hop among different q0 sets and different q0 sizes, e.g., for large q0 sets and small q0 sets based on pre-defined or (pre-)configured hopping patterns. Some monitoring rules may also be applied for different q0 sets and sizes. In addition, primary q0 set and secondary q0 set may also be defined with different priorities. The methods may also be applicable to the q1 set. In another example, WTRU may be configured with a q0 set. WTRU may measure beam qualities of BFD-RSs of the q0 set using the first measurement metric (e.g., L1-RSRP). Based on the first measurement metric (e.g., L1-RSRP), the WTRU may select a subset of resources (q0′) of q0 set, e.g., one or more of the BFD-RSs with highest measurement or BFD-RSs with a measurement above a threshold. The WTRU may monitor beam quality using the second measurement metric (e.g. hypothetical PDCCH BLER) and may determine beam failure based on q0′ subset.

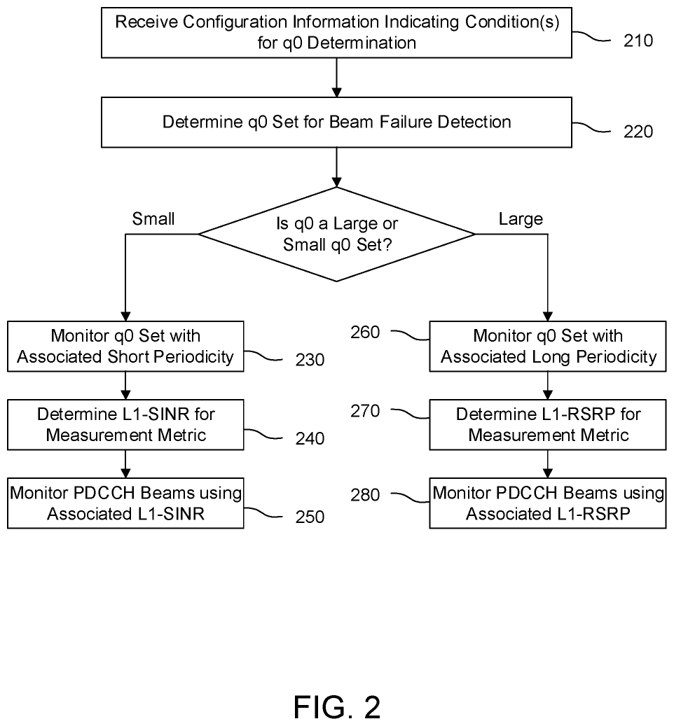

FIG. 2 illustrates an example method of an adaptive q0 mechanism. A WTRU may be configured or pre-configured with condition(s) to determine the q0 set and/or size for MIMO (e.g., massively-distributed MIMO, cell-free MIMO, or user-centric MIMO). For instance, as shown at 210, the WTRU may receive configuration information indicating such conditions for q0 determination in one or more messages or signals. For example, the signals or messages may include RRC messages, layer-2 messaging (e.g., one or more MAC control elements (CEs), control information such as layer-1 control information (e.g., downlink control information or DCI), or any logically equivalent message). As shown at 220, the WTRU may determine the q0 set for beam failure detection for MIMO. If it is small q0 set, as shown at 230, then the WTRU may monitor the q0 set with an associated short periodicity. If it is large q0 set, as shown at 260 then the WTRU may switch to monitor the q0 set with an associated long periodicity to reduce power. The WTRU may determine to use L1-SINR as the measurement metric if q0 is a small q0 set with short periodicity, as shown at 230. It should be appreciated that in other embodiments not shown, the WTRU may determine to use another measurement metric for a small q0 set. On the other hand, as shown at 270, the WTRU may determine to use L1-RSRP as the measurement metric if q0 is a large q0 set configured with long measurement periodicity to reduce complexity. It should be appreciated that in other embodiments not shown, the WTRU may determine to use another measurement metric for a large q0 set. The WTRU may monitor PDCCH beams using the associated measurement metric. As shown at 250, the WTRU may monitor PDCCH beams using L1-SINR measurements (or a different measurement metric determined for use with a small q0 set). The WTRU may perform such monitoring using a short measurement periodicity, for example, in the case of a small q0 set. As shown at 280, the WTRU may monitor PDCCH beams using an L1-RSRP measurement (or a different measurement metric determined for use with a large q0 set). The WTRU may perform such monitoring using a long periodicity, for example, in the case of a large q0 set.

In the following paragraphs, methods for partial beam failure detection are proposed for MIMO (e.g., massively-distributed MIMO, cell-free MIMO, or user-centric MIMO) systems. Partial beam failure detection is one possible solution to reduce latency and delay as well as reduce system complexity for MIMO based BFR. In a MIMO deployment, in order to avoid the long delay due to the long procedure of beam failure recovery, a WTRU may declare partial beam failure based on certain criteria. For example, if a condition or a set of conditions are met, then a WTRU may declare partial beam failure. One example is that if the number of beams for which beam failure is detected is greater than a threshold, e.g., M, then partial beam failure is detected. In this case, the WTRU may refrain from measuring NBI-RS resource sets. Instead, the WTRU may send a beam switch request (BSR), beam switch recommendation, or beam switch order (BSO) to a base station or one or more TRPs.

If all the beams in a BFD-RS resource set are detected to have a beam quality below a predefined or (pre-)configured threshold, then regular or full beam failure detection may be performed. In this case, a WTRU may proceed with measures one or more RSs of an NBI-RS resource set. After measuring RSs of an NBI-RS and finding a new beam, then the WTRU may send a beam failure recovery request to a base station or one or more TRPs.

If the threshold M is set to be equal to the number of BFD-RS resources in a set, then the WTRU may recognize regular (full) beam failure detection upon detection of beam failure for all beams of the BFD-RS resource set. If the threshold M is set to be less than the number of BFD-RS resources in a set, then the WTRU may recognize partial beam failure upon detection of beam failure for a number of beams of the BFD-RS resource set that exceeds the threshold M. Different values of the threshold M may be configured for different BFD-RS resource sets. For example, M1, M2, M3, etc., may be configured for BFD-RS resource set 1, BFD-RS resource set 2, BFD-RS resource set 3, etc., respectively. Alternatively or additionally, a common value of M may be configured for all BFD-RS resource sets. For example, M may be configured for BFD-RS resource set 1, BFD-RS resource set 2, BFD-RS resource set 3, etc. Furthermore, a group-common threshold M may be configured for a group of BFD-RS resource sets. Other combinations may also be possible. The threshold M (or multiple thresholds M1, M2, M3, etc. may be configured along with or separate from the configuration of the BFD-RS or NBI-RS resource sets. For example, a WTRU may receive one or more include RRC messages, layer-2 messaging (e.g., one or more MAC control elements (CEs), control information (e.g., downlink control information), or any logically equivalent message) indicating the one or more thresholds.

BFD-RS resources corresponding to some TRPs may be configured to trigger partial beam failure detection, while BFD-RS resources corresponding to other TRPs may be configured to trigger regular (full) beam failure recovery. If the BFD-RS resources corresponding to some TRPs are configured to trigger partial beam failure detection, with the WTRU, upon detecting partial beam failure for BFD-RS resources associated with those TRPs, may not conduct regular beam failure recovery. For those BFD-RSs corresponding to TRPs with partial beam failure detection, a WTRU may send a beam switch request, recommendation, or order for those TRPs. The WTRU may not send beam failure recovery requests. Those TRPs configured to trigger partial beam failure detection may communicate with the WTRU to reconfigure BFD-RS resource sets. For those TRPs with regular beam failure recovery enforced, the WTRU may not send beam switch orders. Instead, the WTRU may send beam failure recovery requests for those TRPs with regular beam failure recovery.

Furthermore, if BFD-RS resources corresponding to a set of TRPs are configured to trigger regular beam failure detection, it is still possible that beam failure detection may be performed for TRPs and beam failure recovery are conducted for some TRP(s) of the set, but not for other TRP(s). That is, whether beam failure recovery is performed by the WTRU may be determined separately for different TRPs. For example, whether beam failure recovery is performed may be contingent upon beam failure having been detected or declared. If beam failure has not been declared for one or more TRPs, then beam failure recovery may not be conducted by the WTRU for those TRPs. In other words, WTRU may detect beam failure for TRP1 but not detect beam failure for TRP2. The WTRU may conduct beam failure recovery procedures for TRP1 but not conduct beam failure recovery procedures for TRP2.

On the other hand, if BFD-RS resources corresponding to a set of TRPs are configured to trigger partial beam failure detection, then partial beam failure detection may be performed for the TRPs. A WTRU may transmit beam switch requests, beam switch recommendations or beam switch orders for all TRPs.

A network (NW) may configure a WTRU with PDCCH resources, e.g., CORESETs and search space sets (SSS) for PDCCH monitoring at WTRU. The NW may reconfigure a BFD-RS resource set. For example, the NW may transmit a PDCCH transmission (or another logically equivalent message) carrying a transmission configuration indication (TCI) to indicate TCI state to WTRU for monitoring PDCCH beam at WTRU. The NW may reconfigure another, better set of BFD-RS resources for beam failure detection and monitoring at the WTRU. A better set of BFD-RS resources may include BFD-RS resources with most or all of the BFD-RS resources in the set having a better link quality (e.g., SINR or other metrics above e.g., (pre-)configured or indicated threshold(s)). If a better set of BFD-RS resources is reconfigured and indicated to WTRU, the WTRU may not need to move to stage 2 for new beam identification and measure a large set of NBI-RS resource sets. Instead, the WTRU may monitor PDCCH beams in the smaller but better set of BFD-RS resources. By doing so, a longer procedure for beam failure recovery may be avoided or mitigated.

This method may have advantages of lower latency and reduced complexity. Since the WTRU may not need to perform an entire beam failure recovery procedure, latency may be reduced. In addition, since the WTRU may not need to measure a large set of NBI-RS resource sets, the complexity of operations may be lower at the WTRU. The threshold of the number of beams for which beam failure is detected before partial beam failure may be declared, i.e., M, may be configured, preconfigured or predefined by the NW or base station.

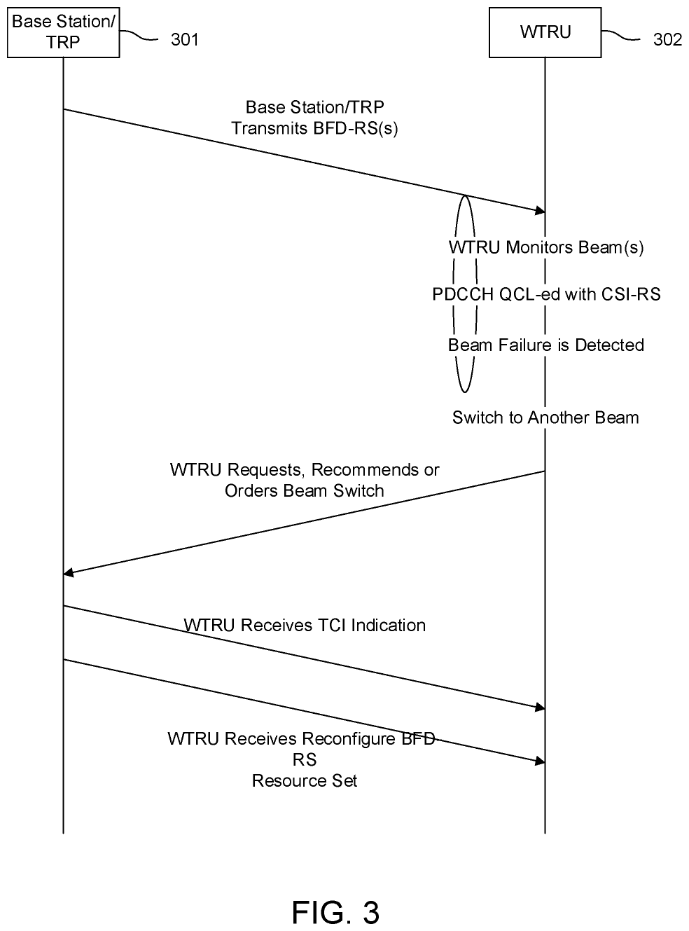

FIG. 3 illustrates an method of partial beam failure detection. As shown in FIG. 3, a base station/TRP 301 may transmit a BFD-RS that may be monitored, detected, and/or measured by a WTRU 302. The base station/TRP 301 may configure the WTRU 302 (or may have previously configured the WTRU 302) with a set of RS resources, e.g., a set of CSI-RS resources for BFD-RS. The WTRU 302 may monitor beam(s) for PDCCH transmissions (e.g, PDCCH DM-RS(s)) that are quasi co-located (QCL-ed) with CSI-RS(s). If beam failure is detected by the WTRU 302, the WTRU 302 may switch to monitor another beam (e.g., in BFD-RS). The WTRU 302 may transmit a request, recommendation, or order to the base station/TRP 301 for beam switch. The base station/TRP 301 may transmit a message or a signal that indicates a TCI state to the WTRU 302 for the beam switch. The base station/TRP 301 may reconfigure a BFD-RS resource set or configure a new BFD-RS resource set for the WTRU 302. For example, a base station/TRP 301 may activate or re-activate TCI states and the WTRU 302 may derive BFD-RS resources implicitly from active TCI states. By doing so, the WTRU 302 may have a better BFD-RS resource set and thus better beams for PDCCH monitoring. This may reduce the chance of beam failure.

In the following paragraphs, methods for priority-based beam failure detection are proposed for MIMO (e.g., massively-distributed MIMO, cell-free MIMO, or user-centric MIMO) systems. A WTRU may need to monitor a set of beams q̅_{0,i} where i=1 . . . M of periodic CSI-RS (P-CSI-RS) resources configuration indices used for beam failure detection. If M is large and a WTRU's CSI processing unit is limited in the frequency or timing at which it may perform measurements, then the WTRU may need to carry out the priority-based beam failure detection procedure to monitor P-CSI resources or a portion of the P-CSI resources. For example, the WTRU may be configured with a large set of P-CSI-RS resource indexes and those resources may be ordered with respect to priority or ordered in partitions, with different partitions having different associated priorities. The WTRU may start with, e.g., the high-priority partition or highest priority partition of the P-CSI-RS/BFD-RS resources to perform beam failure detection. The priority may be dependent on requirements, service types, quality of service (QoS), etc. For example, for high priority service (e.g., URLLC), the WTRU may monitor an entire set (all partitions) that may have a large overhead. For a low priority service, the WTRU may not monitor all resources of the set, but may monitor only certain partition(s).

When monitoring q̅_{0,i}, P-CSI-RSs/BFD-RSs may have associated priorities, and the number of monitored P-CSI-RS/BFD-RS may depend on WTRU's capability, i.e., the capability or capacity of the CPU. If the monitored set exceeds its capability, a WTRU may drop low priority sets from monitoring.

The following priority criteria may be proposed. For q̅_{0,i} configured for a PCell or PsCell, one or more P-CSI-RS resources may have higher priority than any q̅_{0,i} configured for SCells. The P-CSI-RS resources may have corresponding indices that are associated with priority values that are higher that priority values associated with P-CSI-RS resources configured for SCells. For q̅_{0,i} considering resources of a PCell or PsCell as the primary set, the CSI-RS resource indices may be ordered from low to high based on their associated priority value. For example, a lowest resource index of CSI-RS may have a highest priority, while a highest resource index of CSI-RS may have a lowest priority. For example, resources utilized for URLLC service may be assigned with the lowest CSI-RS resource index than resources utilized for other channels.

Consider resources for a SCell as the second priority set, i.e., the resources for the SCell may have a lower priority than PCell or PsCell and the priority may be dependent on SCell's ID relative to IDs of other SCells, which may have IDs ordered from low to high. For example, SCell #1 may have a higher priority than SCell #2, and so on. Within resources for the same SCell, the priority of each of the resources may be based on a CSI-RS resource index from low to high. For example, a lowest resource index of the CSI-RS may be associated with a highest priority, while the highest resource index of the CSI-RS may have the lowest priority.

The measurement metric associated with q̅_{0,i} may be based on L1-SINR for the primary set (e.g. PCell/PsCell), and L1-RSRP for the secondary set. It should be appreciated that other measurement metrics discussed herein may be used in other examples.

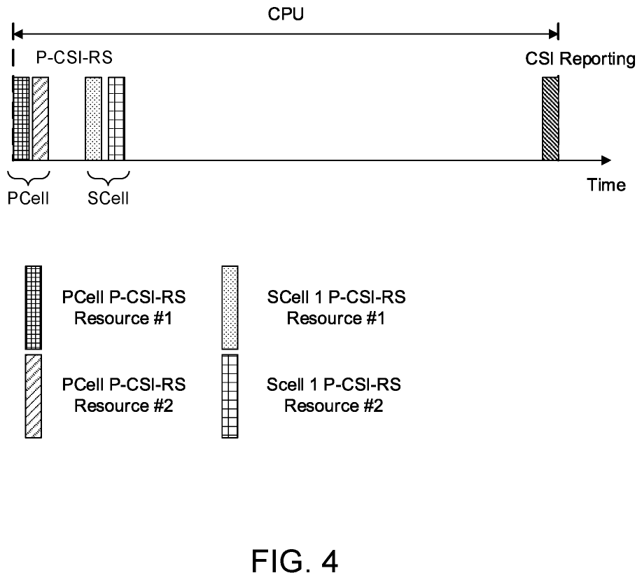

FIG. 4 is an illustration of an exemplary design for priority-based beam failure detection. For example, as shown in FIG. 4, in a constrained CPU time, a WTRU may allow four CSI measurements (e.g., two L1-SINR, two L1-RSRP). In addition, the number of configured CSI-RS resources for PCell/PsCell may be equal to two, the configured SCells may have indices #1 and #2, and each SCell may be configured with two CSI-RS resource indices, respectively. In this exemplary design, the WTRU is only capable of performing four CSI measurements; according to the proposed priority rule, CSI-RS resources associated with the lowest two CSI-RS resource indices for the PCell/PsCell may have higher priorities than CSI-RSs of other SCells. Thus, as shown in FIG. 4, the CPU performs measurements for the PCell (i.e., using P-CSI-RS resources #1 and #2) first. Further as shown the PCell P-CSI-RS resource having the higher priority (i.e., resource #1) is measured first, while the PCell P-CSI-RS resource having the lower priority (i.e., resource #2) is measured subsequently. Similarly, the WTRU may perform CSI measurements for SCell resources based on their respective priority levels. As shown in FIG. 4, SCell P-CSI-RS resource #1 has a higher priority than SCell P-CSI-RS resource #2.

Methods for new beam identification for MIMO (e.g., massively-distributed MIMO, cell-free MIMO, or user-centric MIMO) are proposed herein. In addition, methods of providing BFR assistance information for enhanced MIMO are proposed. A WTRU may be configured to determine parameters, preconfigured with such parameters, or receive configuration information (e.g., via a MAC CE, RRC, other higher-layer signaling, or a logical equivalent thereof) that provides parameters to be used in the identification of one or more new beams, If a candidate beam set is configured for determining and/or reporting NBIs, the WTRU may check the candidate beam set q̅_{1,i} i=1 . . . M for NBI. If a new beam is identified based on the determined, configured, or preconfigured parameters, then the WTRU may transmit, for example, a BFRQ that includes information indicating the NBI, or the NBI with additional information that may assist the network for evaluation. The reporting for NBI only, or NBI with assistance information, may be dependent on the received configuration or preconfiguration information. The WTRU may be preconfigured or configured, e.g., via a MAC CE, RRC signaling, other higher layer signaling, or another logical equivalent, with the content provided in the assistance information. The WTRU may report either a beam that is determined to be suitable according to one or more criteria described herein (e.g., a single best or qualified beam (e.g., CRI, SSBRI, or NBI-RS index)) or multiple suitable or qualified beams (e.g., CRIs, SSBRIs, NBI-RS indices) with the assistance information, etc. For instance, a qualified beam may have a L1-RSRP above a (pre-)configured threshold.

The assistance information may include not only a CSI-RS RSRP (i.e., a measured L1-RSRP for one or more of the candidate beams in q̅_{1,i}) per TRP of the candidate set but also a TRP group (or beam group) recommendation (i.e., group of CORESET IDs, each CORESET ID mapped to a TRP), an average RSRP per TRP (e.g., L1-RSRP averaged over CSI-RSs corresponding to a TRP), etc. In addition, instead of reporting CSI-RS RSRP measurements individually, a WTRU may report differential RSRP measurements to reduce the signaling overhead. This is because reference signal measurements must pass the threshold Q_{in,LR} (rsrp-ThresholdSSB or rsrp-ThresholdSSBBFR) in order for an NBI to be “discovered” or found. Therefore, the following RSRP reporting methods may be proposed to reduce signaling overhead; for example, for each NBI RSRP, either report the (positive) difference between its RSRP and Q_{in,LR} (Note: NBI RSRP≥Q_{in,LR}), or report the difference between its RSRP and Q_{in,LR} for the first NBI and report the difference of RSRP with respect to the first NBI's RSRP for the rest of NBIs.

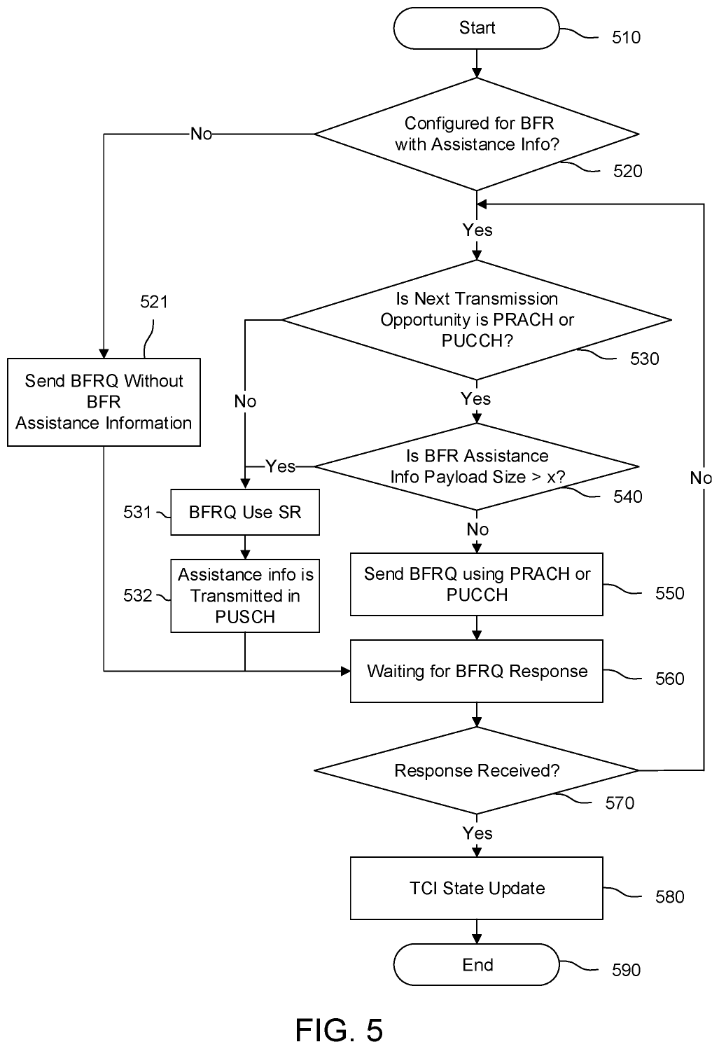

A WTRU may use a PRACH/RACH occasion (RO), PUCCH, or MAC CE (PUSCH), or another logical equivalent, in order to send assistance information when initiating BFR. The WTRU may be configured with a dedicated periodic PRACH occasion, dedicated periodic PUCCH or dedicated periodic PUCCH-BFR-SR resources, periodic PRACH occasion plus periodic PUCCH or periodic PRACH occasion plus dedicated periodic PUCCH-BFR-SR resources, periodic PUCCH plus periodic PUCCH-BFR-SR resources, periodic PRACH occasion plus periodic PUCCH and dedicated periodic PUCCH-BFR-SR resources, or another logical equivalent. More configured BFRQ resources may benefit the WTRU when reporting/initiating BFR with assistance information for the network to determine which TCI state(s) or group of TCI states is/are suitable for WTRU. The selection of whether to use a PRACH, PUCCH, or MAC CE (PUSCH) may be based on certain criteria such as the reporting configuration and/or the payload size (contents of assistance information), etc. For example, the payload size may be based on the individual report, average per TRP report, or average per TRP group report. The selection of a PRACH, PUCCH, or MAC CE may not only be dependent on payload size but may also be dependent on the transmission opportunity. For instance, when a BFRQ is triggered and a WTRU is configured to report BFR assistance information along with the BFRQ, the next coming transmission opportunity for the BFRQ may utilize PRACH (e.g., mostly for PCell/PsCell) or PUCCH (e.g., for SCell) resource. The WTRU may drop part of the BFR assistance information of the whole BFR assistance information and select a RACH occasion (RO) or PUCCH transmission opportunity for BFRQ if the PRACH and PUCCH transmissions are not capable of carrying a sufficiently large load. Otherwise, a WTRU may still use SR methods for BFR assistance information via MAC CEs. The selection procedure is illustrated in FIG. 5, described in further detail below.

FIG. 5 illustrates an example of a procedure performed by a WTRU for beam failure recovery with or without the transmission of assistance information. As shown in FIG. 5 a WTRU starts a beam failure recovery procedure at 510. At 520, The WTRU evaluates whether it is configured to send assistance information when initiating BFR. If not, at 521, the WTRU sends a BFRQ without including BFR assistance information. If the WTRU is configured to send assistance information when initiating BFR, at 530 the WTRU evaluates whether the next transmission opportunity uses PRACH or PUCCH resources. If not, at 531, the WTRU sends a BFRQ using a scheduling request (SR) and sends assistance information separately, at 532, using the PUSCH. On the other hand, if the next transmission opportunity uses PRACH or PUCCH resources, the WTRU further evaluates, at 540, whether the payload size of the BFR assistance information exceeds a given size, x. If so, the WTRU sends the BFRQ using an SR at 531 and sends the assistance information via the PUSCH at 532. If the assistance information does not exceed the given size, x, the WTRU sends the BFRQ using the PRACH or PUCCH transmission opportunity, including the assistance information, shown at 550. Once a BFRQ has been sent, the WTRU waits for a BFRQ response from the network, shown at 560. A response may include, for example, an indication of an updated (or activated) TCI state or TCI states. At 570, if a response has not been received, the WTRU again evaluates the next transmission opportunity. If a response has been received, at 580, the WTRU monitors a new beam or set of beams in accordance with the updated TCI state, before ending the BFR procedure as shown at 590. Assistance information may include but is not limited to an index of an identified NBI-RS, an index of failed a NBI-RS, the index of the failed BFD-RS or set, the cell index of a failed cell, individual L1-RSRP for NBI-RS, averaged L1-RSRP (e.g., average per CSI-RS set, per CSI-RS set group, per TRP, per TRP group, etc.), differential L1-RSRP with respect to average, differential L1-RSRP with respect to threshold, or the like).

In addition, the network may activate and deactivate a PUCCH when PUCCH resources for BFRQ are not used to reduce overhead. The network may decide the activation or deactivation based on some criteria, e.g., the number of BFRQ (whether BFRQ happens frequently or not) in a period.

For a large payload carrying assistance information, if a one-shot PUCCH transmission is not sufficient to carry the payload, a WTRU may transmit assistance information using a second or third PUCCH transmission with same or different formats (e.g., long PUCCH format) to send. For example, the first PUCCH transmission may be used for indication of a BFRQ request and higher priority information such as a CRI, SSBRI, NBI-RS index, and then a second PUCCH transmission may carry BFRQ assistance information e.g., CSI-RS RSRP per TRP, etc. The number of reports and report size may be configured and may depend on the WTRU's capabilities. In addition, if the payload size i.e., the BFR assistance information is greater than a threshold, then the WTRU may request a BFR scheduling request (BFR-SR). Once the network receives the BFR-SR, the network may schedule a UL grant for the WTRU to send a PUSCH transmission (e.g., MAC CE or another logical equivalent) for carrying the BFR assistance information.

Methods for performing different RACH procedure types based on implicit indications are proposed for MIMO (e.g., massively-distributed MIMO, cell-free MIMO, or user-centric MIMO) systems. In stage 2 of a BFR procedure, a WTRU may check a q1 candidate beam set, which may be a much larger set than q0 set, determine whether BFR is being carried out for a MIMO system. A large q1 set may enhance performance of new beam identification but at the same time could also incur large overhead and long latency. If NBI does not succeed, a WTRU may initiate contention-based random access. This may incur long delay and high overhead due to entire random access procedures are performed

If NBI does not succeed, a WTRU may select a RACH procedure type based on certain criteria and/or condition(s). For example, a WTRU may perform a 2-step RACH procedure if fast, low latency and low delay are required. A WTRU may perform a 4-step RACH procedure if higher reliability (although longer delay), etc. are required. In addition, a WTRU may perform a 2-step or 4-step RACH procedure based on service types, beam condition(s), traffic requirements or other criteria.

Methods for distinguishing between initial random access or beam failure triggered random access may be needed. Implicit indication may be used. Partitioning PRACH and/or RACH resource and/or DMRS ports and/or PUSCH resources may be used for implicit indication. For example, one partition may be dedicated for initial random access, and another partition may be dedicated for BFR.

Partitioning of PRACH resources/RACH opportunities (ROs) and/or DMRS port and/or PUSCH resources and/or PUSCH occasions may be used for MsgA in the case that a 2-step RACH procedure is carried out.

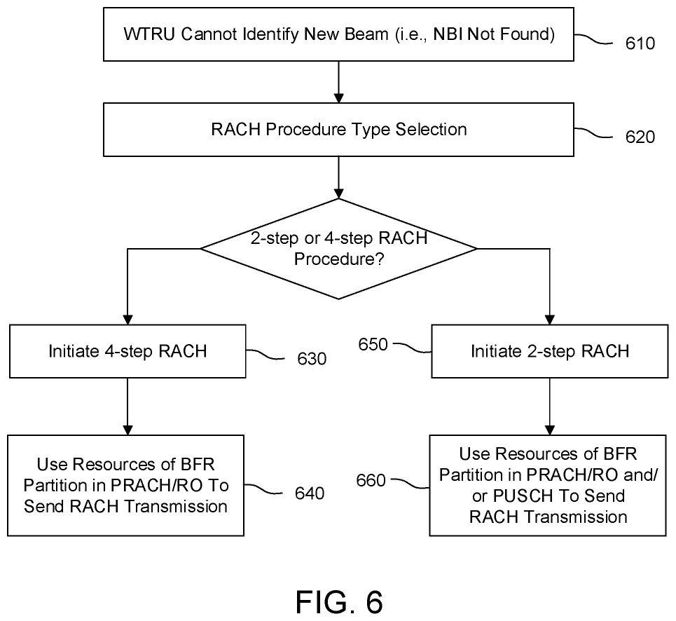

FIG. 6 illustrates an example method of a BFR-based random access procedure with implicit indication. As shown in FIG. 6 at 610, a WTRU may be unable to identify a new beam, and unable to issue a NBI. In such case, at 620, the WTRU may select between the two types of RACH procedures, namely 2-step or 4-step random access procedures. The RACH type selection may be based on service types, conditions, criteria or other parameters. In some examples, if low latency is required, then the WTRU may initiate a 2-step RACH procedure. In some examples, such as if higher reliability is required, then WTRU may initiate a 4-step RACH procedure, shown at 630. In some examples, in order to reduce the total number of BFR related messaging, if lower number messaging is required, then the WTRU may select a 2-step RACH procedure, as shown in FIG. 6 at 650 because the 2-step RACH procedure uses two messages in total compared to four messages used in a 4-step RACH procedure. This option in turn may reduce the cumulative number of BFR-related messages exchanged in a massive MIMO system.

To distinguish between initial random access and beam failure triggered random access, implicit indications may be used for lower overhead. For implicit indications, in case of 4-step RACH, PRACH and/or RACH occasion (RO) and/or PRACH resources in Msg1 may be partitioned to denote initial random access and BFR triggered random access. For implicit indication, in the case of 2-step RACH procedure, PRACH and/or RO and/or PRACH resources and/or DMRS ports and/or PUSCH resources in MsgA may be partitioned to denote initial random access and BFR triggered random access. Based on the partition, in case of 4-step RACH, and shown in the example of FIG. 6 at 640, a WTRU may use a BFR partition on PRACH/RO resources in Msg1 for random access. As is further shown in the example of FIG. 6 at 660, based on the partition, in the case of 2-step RACH, a WTRU may use BFR partition on PRACH/RO and/or PUSCH resources in MsgA for random access. Resource partitioning may be performed over a combination of time, frequency and code domains.

Methods for beam failure recovery request for MIMO (e.g., massively-distributed MIMO, cell-free MIMO, or user-centric MIMO) are proposed. Methods of flexible beam failure recovery (BFR) management are proposed for enabling operation flexibility and performance for MIMO. Methods of two stage BFR request (BFRQ) for flexible BFR management may be considered. A two stage BFRQ may be used to reduce overhead and enable flexible BFR management. In such methods, a small piece of information with a small payload size may be sent in the 1st stage BFRQ, which is then followed by a large piece of information with a larger payload size if needed. The large piece of information with large payload size may be sent in the 2nd stage BFRQ.

A WTRU may send the first stage BFRQ and may expect to receive the NW response. The WTRU may send the second stage BFRQ with more information if needed, and whether further information is needed may be indicated in the first NW response.

By doing so, a flexible BFR management may be achieved and signaling overhead may be managed. In addition, a trade-off between overhead and reliability may be achieved. The first NW response may indicate whether the second stage BFRQ is needed. It is also possible that the second stage BFR report (BFRR) may be used instead of the second stage BFRQ. The first NW response may indicate whether more information is required or not and what kind of format for more information may be used. The WTRU may choose between BFRQ and BFRR in case the second stage information is needed.

After sending the second stage BFRQ or BFRR, the WTRU may expect to receive a subsequent NW response which is the second NW response.

Different containers may be used for the 1st stage information (e.g., BFRQ) and the 2nd stage information (e.g., BFRQ, BFRR) due to different information sizes. For example, the 1st stage information or BFRQ may use a PRACH transmission, and the 2nd stage information, BFRQ or BFRR may use a PUCCH transmission. The PUCCH transmission may be sent, for example, without an uplink grant. The 2nd stage information, BFRQ or BFRR may use a MAC CE or a logical equivalent as well. In some examples, the BFRQ may use a PUCCH transmission or a logical equivalent and the BFRR may use a MAC CE or a logical equivalent.

In some examples, the 1st stage information may use a PUCCH transmission or a logical equivalent that may be configured, and the 2nd stage information may use a MAC CE or a logical equivalent if an uplink grant is present.

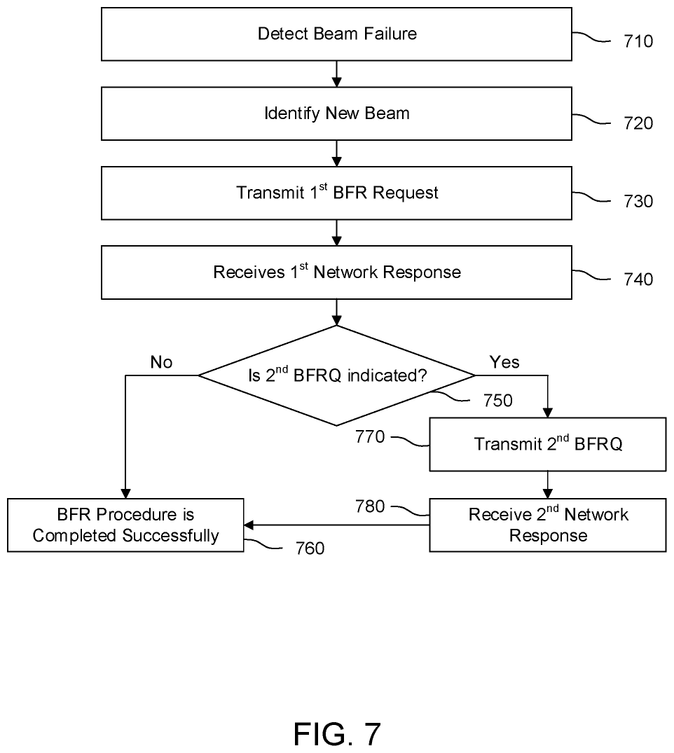

FIG. 7 illustrates an example of a two-stage BFRQ management procedure. As shown in FIG. 7 at 710, a WTRU may detect beam failure. If beam failure is detected, then the WTRU may try to identify a new beam, shown at 720. Once a new beam is identified, as shown at 730 the WTRU may transmit a BFR request (the 1st BFR request). The WTRU may expect to receive a NW response (the first NW response) at 740. The WTRU may evaluate whether If a second BFR request is required, as shown at 750. A base station/TRP may indicate to the WTRU to transmit the second BFR request. If the WTRU receives the indication in a NW response that the second BFR request is needed, then the WTRU may send the second BFRQ, shown at 770, and wait for the subsequent NW response, as shown at 780. If the WTRU receives the second NW response within a predefined or (pre-)configured window, then the BFR procedure is completed successfully as shown at 760. If the second BFR request is not indicated in the first NW response, then the WTRU may not continue to transmit the second BFRQ and receive the subsequent NW response. In this case, the BFR procedure is also declared to be successfully completed, as shown at 760. The second BFR request may be indicated in downlink control information (DCI) carried in physical downlink control channel (PDCCH) transmission of the first NW response. A new control field in the DCI may include the indicator of second BFR request to enable two-stage BFRQ procedure.

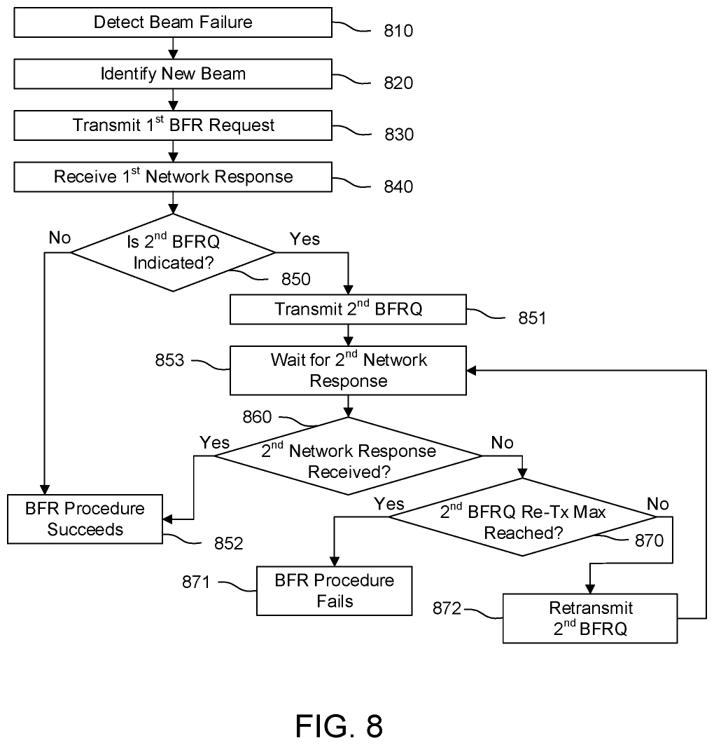

FIG. 8 illustrates an example of a two-stage BFRQ management procedure with maximum number of re-transmissions. As shown in FIG. 8, at 810, a WTRU may detect beam failure. If beam failure is detected, then the WTRU may try to identify a new beam, as shown at 820. Once a new beam is identified, the WTRU may transmit a BFR request (the 1st BFR request), shown at 830. At 840, the WTRU may expect to receive a network response (the first network response). If the second BFR request is required, then a base station/TRP may indicate to the WTRU, via the network response, to transmit the second BFR request. If the second BFR request is not required, and is not indicated by the network response, the WTRU and/or the base station/TRP consider the BFR procedure successful, as shown at 852. If the WTRU receives an indication in the network response that the second BFR request is needed, then, as shown at 851, the WTRU may send the second BFRQ and wait for a second network response (shown at 853) or a subsequent network response (shown at 853). If at 860, the WTRU determines it has received the second network response, then the BFR procedure may be considered completed successfully (against shown at 852). Otherwise, if, at 870, the second BFRQ retransmission does not reach a maximum number of retransmit (re-Tx) attempts, then the WTRU may retransmit the second BFRQ and wait for the subsequent NW response, as shown at 872. If the second BFRQ retransmission reaches the maximum, then the WTRU may declare that the BFR procedure fails, as shown at 871.

If the first network response does not indicate that the WTRU should send a second BFR request, then the WTRU may not be required to continue to transmit the second BFRQ and receive the subsequent NW response. The BFR procedure may then be declared to be successfully completed.

The maximum number of retransmissions for the first and the second BFRQ may be configured differently for performance trade-off, or for enhanced reliability, reduced latency or lower overhead, etc. In addition, a common maximum number of retransmissions for the first and the second BFRQ may also be configured.

Methods of BFRQ reliability enhancement and diversity transmission are proposed for MIMO (e.g., massively-distributed MIMO, cell-free MIMO, or user-centric MIMO). During BFR stage 3, a WTRU may send BFRQ to a base station/TRP according to one or more of the following procedures.

A BFRQ may be sent in a new beam corresponding to single NBI or in multiple beams corresponding to multiple NBIs. For example, the BFRQ may be carried out explicitly through uplink physical signalling (e.g., PRACH transmission).

Multiple NBIs may be associated with one TRP (e.g., NBI-RS set 1) or across multiple TRPs (e.g., NBI-RS set 1, 2, . . . , M). For high reliability and low latency, a WTRU may be triggered to send BFRQ in multiple beams corresponding to multiple NBIs. The WTRU may transmit a single BFRQ in multiple beams corresponding to multiple NBIs or multiple BFRQs in multiple beams corresponding to multiple NBIs. This may in turn result in increased overhead. For low complexity and low overhead, the WTRU may be triggered to send a single BFRQ in a single beam corresponding to single NBI (or one TRP). This may in turn result in low complexity and low overhead at the cost of low reliability.

A BFRQ may be repeated to reduce PRACH retransmissions or HARQ retransmissions. Adaptive multi-stage BFRQ or incremental number of beams corresponding to multiple NBIs for (re-)transmission may be utilized to enhance beam failure recovery procedure. A WTRU may (re-)transmit a BFRQ with either a single beam or with multiple beams. For example, the WTRU may transmit a BFRQ initially with a single beam and retransmit the BFRQ with multiple beams. The WTRU may retransmit the BFRQ with an increased number of beams. For example, for the first BFRQ retransmission, a WTRU may use two beams, and for the second BFRQ retransmission, the WTRU may use three beams, and so on. By doing so, the WTRU may increase the chance to (re-)transmit BFRQ successfully while still maintaining the overall overhead at certain level. The adaptive process may use a BFRQ failure counter where each time instance for BFRQ re-transmission comes with increased capability (e.g., higher number of beams).

The selection of the number of BFRQs and/or number of beams may be based on the relative difference in received versus threshold signal quality such as BLER. A bigger (or smaller) gap between a received signal quality and threshold signal quality may require a higher (lower) number of NBIs.

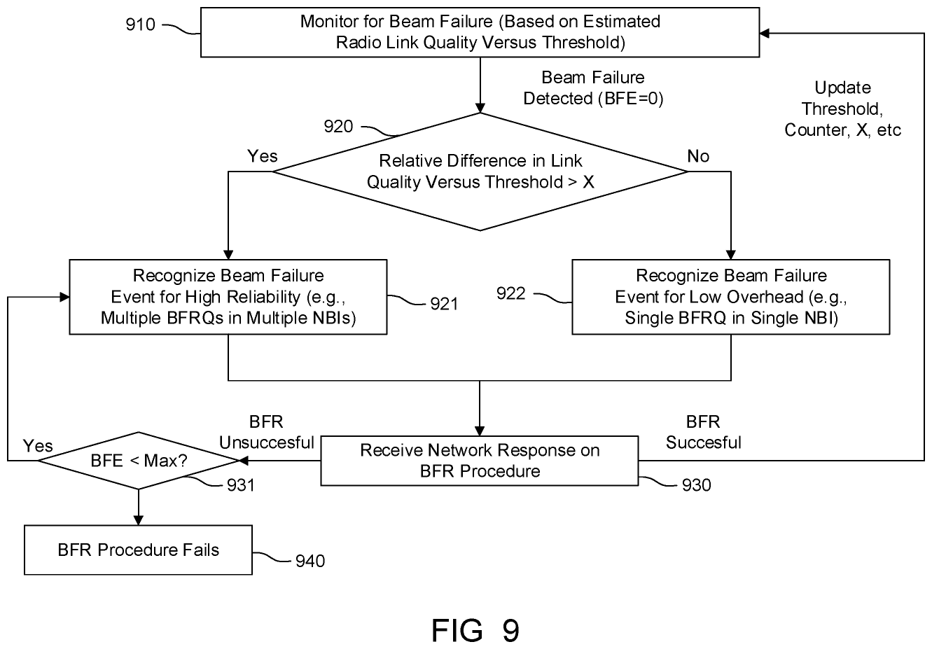

FIG. 9 illustrates an example method for adaptive transmission of BFRQs. As shown in FIG. 9, at 910, a WTRU capable of detecting a beam failure event monitors BFRQ transmissions against one or several quality thresholds. In the cases where the beam quality or radio link quality for the monitored BFRQ transmission falls below set thresholds, a beam failure event may be detected and a counter that tracks a number of beam failure events (BFEs) may be set to “0”. To generate the BFRQ re-transmission, the WTRU may take into account the trade-off between reliability and overhead by assessing the difference in link quality and the one or several quality thresholds. The WTRU then may send a BFRQ through a random access procedure based on the desired choice of trade-off between reliability and overhead, e.g., through the number of NBIs, number of BFRQs, etc. For example, if, at 920, the relative difference in link quality is greater than a given amount, the WTRU may recognize a BFE for high reliability (e.g., multiple BFRQs in multiple NBIs) as shown at 921. If, at 920, the relative difference in link quality exceeds the given amount, x, the WTRU may recognize a BFE for low overhead (e.g., a single BFRQ in a single NBI) as shown at 922. The network may then provide a response on the BFR procedure, which is received by the WTRU, as shown at 930. If the BFR procedure is unsuccessful and the BFE counter is below a set maximum (e.g., based on timing constraints), the WTRU may be requested to generate one or more additional BFRQs with more extensive capability (e.g., additional NBIs). The indication from the network may be explicit (e.g., common or dedicated downlink signaling) or implicit (choice of downlink resource). The process may continue until the BFR is indicated as successful where parameters such as the difference between measured and quality thresholds may be updated through dedicated downlink signaling (e.g., an uplink grant) or implicitly via a choice of downlink resources. The update in threshold may be based on the performance of the BFRQ re-transmission process, for better trade-off between reliability and complexity for future beam failure events. Otherwise, the BFR procedure may have failed in re-establishing a connection and link recovery procedures may be required.

Methods by which a network may respond to BFRQs are described for MIMO (e.g., massively-distributed MIMO, cell-free MIMO, or user-centric MIMO). After receiving a BFRQ, the network may decide to confirm or reject the BFRQ based on metrics such as service availability, resource availability. In some methods, the network may send confirmation of the new NBI in DCI as a new DCI field, NBI_confirmation. If the NBI_confirmation field is set to 1, then the WTRU may use the new NBI. For example, if the NBI_confirmation field is 0, then the WTRU may receive a new TCI state/panel selection that overrides the WTRU's recommendation for the new beam.

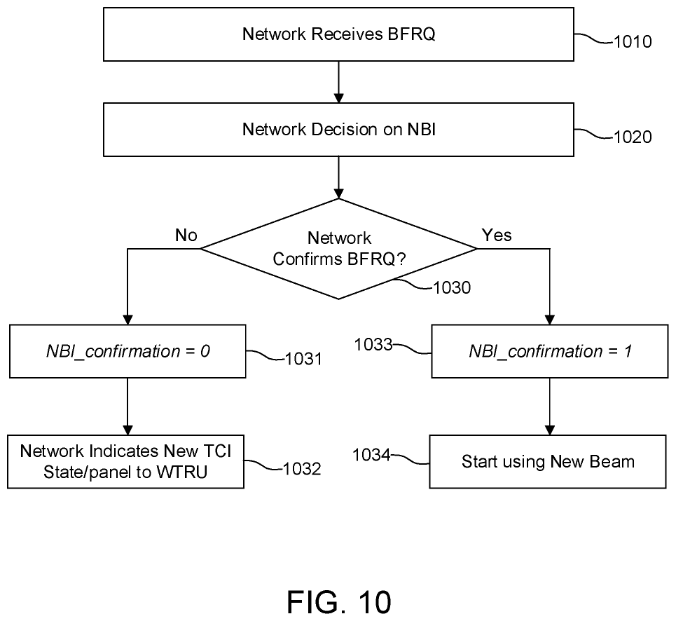

FIG. 10 illustrates an example method by which a network may respond to a BFRQ. As shown at 1010, a network receives a BFRQ transmitted by a WTRU. The network decides, at 1020, whether to confirm or rejection the BFRQ, based on one or more metrics described in paragraphs above. If, at 1030, the network confirms the BFRQ, the network sends a message to the WTRU that includes a parameter or field confirming the BFRQ. As shown at 1033, the parameter or field may be a one-bit (or two-bit) field with a value of 0 or 1. Upon transmission/reception of the message confirming the BFRQ, the network and WTRU may start using a one or more new beam(s), as shown at 1034. If, at 1030, the network rejects the BFRQ, the parameter or field value is set to 0, indicating that the network rejects the BFRQ, as shown at 1031.

In some sets of methods, as shown in FIG. 10 at 1032. after receiving BFRQ, the network may directly override the WTRU's recommendation by sending a TCI state/panel selection message to the WTRU. Then, WTRU may use the new beam indicated by the network.

In some sets of methods, in the DCI or another logically equivalent message, the WTRU may receive a new field that indicates the TCI state to confirm or override the WTRU's recommendation for beam. This would be a new field with longer bitwidth such as 4 bits to indicate TCI state. As an example, 1111 may denote confirmation, and other combination may denote other 15 potential TCI states.

Methods of WTRU-controlled beam failure recovery are proposed for MIMO (e.g., massively-distributed MIMO, cell-free MIMO, or user-centric MIMO). A WTRU controlled BFR with beam failure recovery order is proposed. Event-triggers and/or condition-based BFR may be used. Based on certain criteria and condition(s), a new set of NBI-RS resources may be triggered, and a WTRU may switch to measure the new set of NBI-RS resource set from the original set of NBI-RS resources. This may be used to prevent the WTRU from not finding any qualified NBI-RS resource and enter to contention-based random access procedure which may have large latency and long delay.

In some cases, q1 may be poor, original NBI-RS resources may not be in good quality, or NBI or new beam(s) may not be found. In such cases, a contention-based 4-step random access may be triggered.

In addition, even if it passes the new beam identification, however, there may be a good chance that BFRQ may not reach TRP when beam conditions are poor. In such cases, BFR procedures may not be able to continue, and beam failure recovery may not be completed.

Based on a pre-configuration, a WTRU may control BFR. The WTRU may autonomously switch to the new NBI-RS resource set. The WTRU may find a NBI from the new NBI-RS resource set.

Primary and secondary sets for q1 or NBI-RS resource set may be defined. A WTRU may monitor and measure the primary NBI-RS resource set. When channel and/or beam quality and/or condition deteriorate, become not reliable or drop below certain threshold, secondary NBI-RS resource sets may be triggered. The WTRU may first monitor and measure the primary NBI-RS resource set, and switch to secondary NBI-RS resource set if channel and/or beam quality and/or condition deteriorate. The WTRU may autonomously perform the switch of NBI-RS resource set based on criteria and/or conditions.

In addition, the associating measurement metric may be configured or pre-configured. One measurement metric may be associated with a primary set and another measurement metric may be associated with a secondary set. For example, L1-SINR may be used for and associated with primary NBI-RS resource set, and L1-RSRP may be used for and associated with the secondary NBI-RS resource set. In some examples, L1-RSRP may be used for and associated with both primary and secondary NBI-RS resource sets.

A base station (e.g., base station) may configure a secondary NBI-RS resource set in addition to a primary NBI-RS set. If channel conditions deteriorate (e.g., L1-RSRP<T1, L1-SINR<T2), the WTRU may switch to the secondary set. Other condition(s) or criteria may also be considered, such as a number of PDCCH transmissions transmitted without an ACK response, a missing PDCCH transmission, a number of NACKs or ratio of NACK/ACK >threshold, etc.

A WTRU-controlled BFR with beam failure recovery order may be used. A WTRU may transmit the beam failure recovery order to NW and control BFR procedure. The WTRU may inform a base station/TRP about its decision. The WTRU may ask a base station/TRP to switch to the new NBI-RS resource set and new beams for measurement and monitoring.

A WTRU may use a new beam (e.g., not in the primary NBI-RS resource set that the base station decides, but in the secondary NBI-RS resource set or new NBI-RS resource set that WTRU decides) for further communications with the base station and/or TRPs, e.g., transmitting BFRQ to the base station/TRP. After a BFR procedure is successfully completed, both the base station/TRP and WTRU may switch to the WTRU-selected new beam.

Primary and secondary NBI-RS resource sets may not be uniform and may have different sizes for the resource sets. A primary NBI-RS resource set may always have a high priority. A secondary NBI-RS resource set may have a lower priority. In addition, secondary NBI-RS may have multiple resource sets, each with different associated priority. A WTRU may be enabled or configured with this feature. The WTRU may transmit a beam failure recovery order (BFRO) via the selected beam that is selected from secondary NBI-RS resource set when channel and/or beam conditions deteriorate or drop below a certain threshold. Otherwise, the WTRU may initiate a 4-step random access procedure with a long delay.

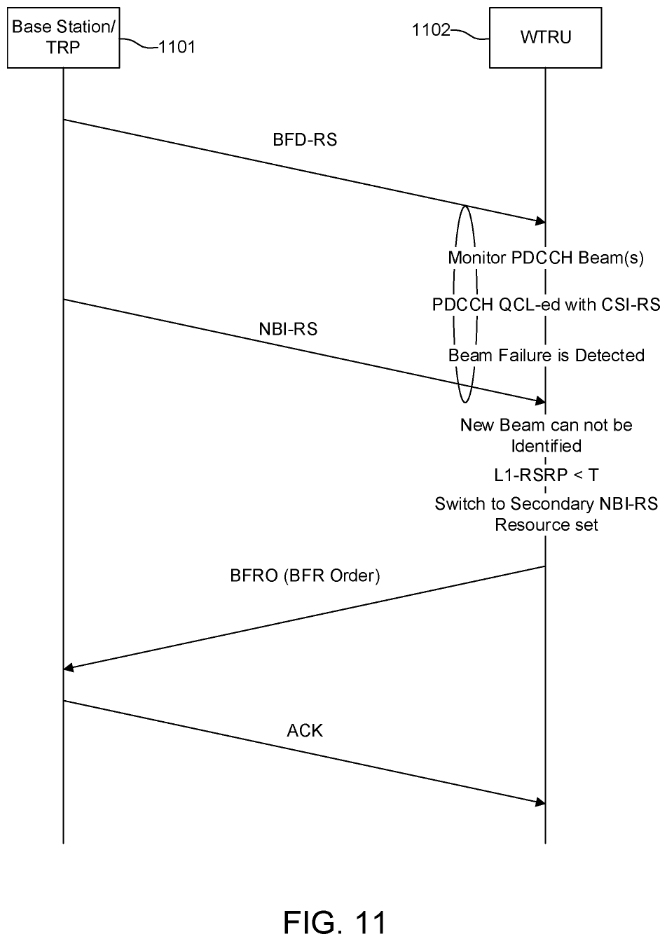

FIG. 11 illustrates an example method of WTRU-controlled beam failure recovery. A base station/TRP 1101 may transmit BFD-RSs, which may be detected or received by the WTRU 1102. WTRU 1102 may monitor PDCCH beams accordingly. For example, the WTRU 1102 may monitor PDCCH DMRSs (i.e., PDCCH beams) that are QCL-ed with CSI-RS. If the qualities of the PDCCH beams are not good e.g., measurements are below a certain threshold, then beam failure is detected. The WTRU 1102 may then start to monitor NBI-RSs to search for a new beam that has qualified link (e.g., measurement is above a certain threshold). If no such beam is found, e.g., L1-RSRP is below a certain threshold, T, then the WTRU may switch to a new NBI-RS. For example, the WTRU 1102 may autonomously switch to a new NBI-RS, or a secondary NBI-RS resource set for searching for a new qualified beam. If a new beam is identified, then the WTRU 1102 may transmit a BFR order (BFRO) to the base station/TRP 1101. The base station/TRP 1101 may acknowledge the BFRO that is received. The WTRU 1102 may control the BFR procedure during the situations where channel/beam conditions deteriorate. Since the WTRU 1102 may determine to have another chance to find a new beam in a new set of NBI-RS resources, the WTRU 1102 may avoid the chance to initiate the contention-based random access procedure with long delay.

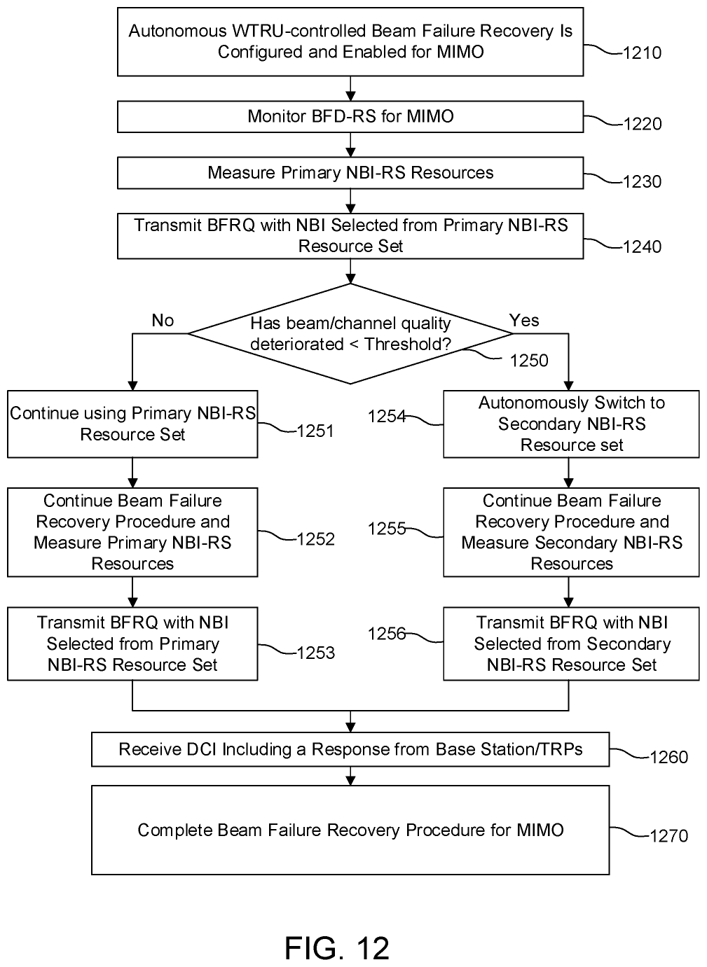

FIG. 12 illustrates an example procedure of WTRU-controlled beam failure recovery procedure. As shown at 1210, a WTRU may be configured to utilize autonomous WTRU-controlled beam failure recovery for a MIMO (e.g., massively-distributed MIMO, cell-free MIMO, or user-centric MIMO) system. The feature of autonomous WTRU-controlled beam failure recovery may be enabled for used by the WTRU based on, for example, configuration messages, conditions.

As shown at 1220, the WTRU may monitor BFD-RSs for the MIMO system. The WTRU may first measure primary NBI-RS resources, as shown at 1230. The WTRU may transmit, at 1240, a BFRQ using an NBI selected from the primary NBI-RS resource set. At 1250, the WTRU evaluates beam/channel quality for the primary NBI-RS resource set. If a beam/channel quality deteriorates (e.g., measurement such as L1-RSRP, L1-SINR is below a (pre-)configured threshold), the WTRU may autonomously switch to a secondary NBI-RS resource set, shown at 1254. As shown at 1255, the WTRU may continue the beam failure recovery procedure and measure secondary NBI-RS resources. At 1256, the WTRU may transmit a BFRQ using an NBI selected from the secondary NBI-RS resource set. The WTRU may receive DCI via a PDCCH for the response from base stations/TRPs, as shown at 1260. At 1270, the WTRU may complete the beam failure recovery procedure using the secondary NBI-RS for MIMO.

If, at 1250, the beam/channel quality does not deteriorate (e.g., a measurement such as L1-RSRP, L1-SINR is not below a (pre-)configured threshold), the WTRU may stay in the primary NBI-RS resource set, as shown at 1251. The WTRU may continue the beam failure recovery procedure and measure primary NBI-RS resources, as shown at 1252. The WTRU may, at 1253, transmit the BFRQ with an NBI selected from the primary NBI-RS resource set. The WTRU may receive DCI via a PDCCH for the response from base stations/TRPs, as seen at 1260. At 1270, the WTRU may complete the beam failure recovery procedure using the primary NBI-RS for MIMO.

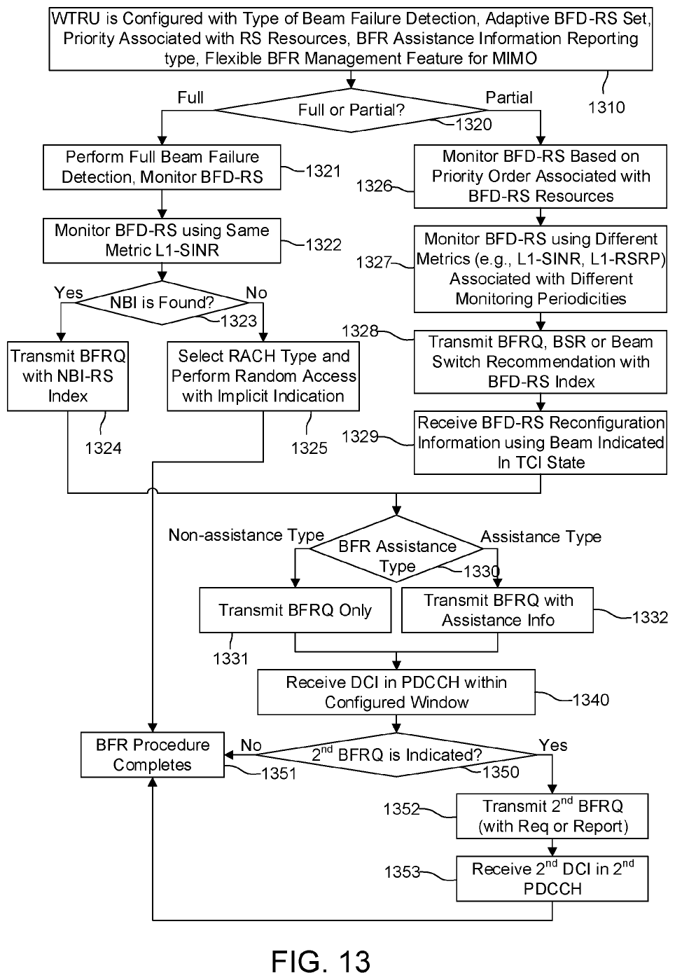

FIG. 13 illustrates an example method of a beam failure recovery procedure for MIMO. It should be noted that the flow diagram provided in FIG. 13 may involve a combination of different methods described separately and in further detail within paragraphs above. Thus, further understanding of FIG. 13 may be taken from other portions of the detailed description. It should be clear to one of ordinary skill in the art, from the example of FIG. 13, that various different solutions for beam failure recovery that are proposed herein may be implemented alone or in any combination. It will be evident to a skilled person that other embodiments not depicted directly in FIG. 13 (for example, embodiments not including each and every step set forth in FIG. 13, or embodiments including other steps not set forth in FIG. 13), are possible.

As shown in FIG. 13, the WTRU may be configured to perform MIMO-based beam failure recovery procedures. At 1310, the WTRU may be configured with various different parameters for beam failure recovery, including, for example: a beam failure detection type, an adaptive BFD-RS set and priority values associated with RS resources. In some embodiments, the WTRU may be configured with a BFR assistance information reporting type, described in greater detail in paragraphs above. The WTRU may be further configured with flexible BFR management features, also described in greater detail in paragraphs above.

As shown at 1320, the WTRU may perform partial beam failure detection if configured. Otherwise, as shown at 1321, the WTRU may perform regular (or full) beam failure detection if configured (to reduce complexity for MIMO), further described in paragraphs below. With respect to the case of partial beam failure detection, at 1326, the WTRU may monitor BFD-RSs based on a priority order associated with the BFD-RS resources. As shown at 1327, the WTRU may monitor BFD-RSs using different metrics (e.g., L1-SINR, L1-RSRP) associated with different monitoring periodicities to further reduce complexity arising from MIMO. The WTRU may transmit a beam failure recovery request (BFRQ) or beam switch request (BSR) based on, for example, the configured beam failure detection type. The WTRU may transmit a BFD-RS index with the BFRQ, BSR, or beam switch recommendation.

At 1328 the WTRU may transmit a BFRQ with BFD-RS index, or the WTRU may transmit a beam switch request (BSR) or beam switch recommendation with BFD-RS index. After the WTRU has transmitted a BFRQ, BSR or beam switch recommendation, at 1329, the WTRU may receive BFD-RS reconfiguration information using a beam indicated in a transmission configuration indication (TCI) state and monitor a reconfigured BFD-RS resource set to reduce BFR complexity in MIMO.

If full beam failure detection is performed at 1321, the WTRU may monitor all BFD-RSs of the set and may monitor the BFD-RS resources using a single metric (e.g., L1-SINR). The WTRU may be configured to transmit a BFRQ including an NBI-RS index or indices if an NBI is found, as shown at 1323 and 1324.

If full beam failure detection is performed, and an NBI is not found as shown at 1323, then at 1325, the WTRU may select a RACH type (e.g., a 2-step or 4-step RACH procedure) e.g., according to one or more methods described in paragraphs above. The WTRU may perform random access based on the selected random access type and the configured or selected indication type for indicating whether the RACH procedure is performed for initial access for beam failure-triggered random access (e.g., an implicit indication as shown in FIG. 13, or an explicit indication). In the case of an implicit indication, for example, the WTRU may perform the RACH procedure using resources associated with beam failure recovery. In the case the WTRU performs random access, the WTRU does not transmit a BFRQ and the BFR procedure is considered complete, as shown at 1351.

As shown at 1330, the WTRU may determine whether transmit a BFRQ with assistance information. For example, if a BFR assistance information type is configured to enhance performance for MIMO-based BFR procedures.

The WTRU may transmit the first BFRQ with a small payload (e.g., without assistance information as shown at 1331, or with assistance information as shown at 1332. The WTRU may receive DCI using a PDCCH transmission sent by the network in response to the BFRQ to reduce overhead associated with MIMO.

As shown at 1340, the WTRU may receive and decode a PDCCH transmission and obtain DCI. If, at 1340, the DCI in the response indicates the subsequent request type, namely, that a second BFR request (BFRQ) type or BFR report (BFRR) type is required, then the WTRU may transmit the second request signal with the indicated type (BFRQ or BFRR) with a large payload, as shown at 1352, and the WTRU may receive second DCI using a second PDCCH transmission from the network, as shown at 1353, to enhance performance and flexibility for MIMO. If the first DCI dies not indicate a subsequent request type or that a second BFRQ is needed, as shown at 1351, the BFR procedure may be considered complete.

The WTRU may retransmit the request signal/channel with indicated type (BFRQ or BFRR) with adaptive NBI and incremental NBIs for each retransmission if the DCI is not received from the network in response. The WTRU may receive DCI(s) in PDCCH transmission(s) that are retransmitted.

The WTRU may complete beam failure recovery procedure within a maximum number of retransmissions for the first and/or second BFRQs for MIMO and may declare that beam failure recovery procedure succeeds for MIMO. Otherwise, the WTRU may declare that beam failure recovery procedure fails for MIMO.

Further examples according to one or more of the above-described solutions are provided herein.

In some examples, a WTRU performs MIMO based beam failure recovery procedures. The WTRU may be configured with a beam failure detection type, adaptive BFD-RS set and priority associated with RS resources. The WTRU may be configured with a BFR assistance information reporting type. The WTRU may be further configured with a flexible BFR management feature. The WTRU may perform one or more of the following steps. For example, the WTRU may perform partial beam failure detection if configured, otherwise perform regular beam failure detection if configured (to reduce complexity for MIMO). The WTRU may monitor BFD-RS based on a priority order associated with BFD-RS resources and using different metrics (e.g., L1-SINR, L1-RSRP) associated with different monitoring periodicities (to further reduce complexity arising from MIMO). The WTRU may transmit a beam failure recovery request (BFRQ) or beam switch request (BSR) based on beam failure detection type. The WTRU may transmit a BFD-RS index or NBI-RS index depending on beam failure detection type. The WTRU may transmit BFRQ with BFD-RS index if partial beam failure detection type is configured. The WTRU may transmit a BSR or beam switch recommendation with BFD-RS index if partial beam failure detection type is configured (to reduce latency for MIMO). The WTRU may transmit a BFRQ with an NBI-RS index if regular beam failure detection type is configured. The WTRU may receive BFD-RS reconfiguration information using beam indicated in a transmission configuration indication (TCI) state, and monitor a reconfigured BFD-RS resource set if partial beam failure detection type is configured (to reduce BFR complexity in MIMO). The WTRU may transmit a BFRQ with assistance information if BFR assistance information type is configured (to enhance performance for MIMO-based BFR). The WTRU may select a random access type if an NBI is not found and perform random access based on the selected random access type (2-step or 4-step) and the configured indication type (explicit or implicit indication).

The WTRU may transmit the first BFRQ with a small payload and receive DCI or another logically equivalent message in a PDCCH transmission that is a NW response (to reduce overhead associated with MIMO). The WTRU may receive and decode the PDCCH transmission and obtain the DCI, if the DCI of the NW response indicates the subsequent request type, namely BFR request (BFRQ) type or BFR report (BFRR) type is required. The WTRU may then transmit the second request signal/channel with indicated type (BFRQ or BFRR) with large payload. The WTRU may receive second DCI in second PDCCH of NW response (to enhance performance and flexibility for MIMO). The WTRU may retransmit the request signal/channel with indicated type (BFRQ or BFRR) with adaptive NBI and incremental NBIs for each retransmission if DCI in PDCCH of NW response is not received. The WTRU may receive DCI(s) in PDCCH(s) that are retransmitted. The WTRU may complete beam failure recovery procedure within maximum number of retransmission for the first and/or second BFRQs for MIMO, and declare that beam failure recovery procedure succeeds for MIMO. Otherwise, the WTRU may declare that beam failure recovery procedure fails for MIMO.

In some examples, the WTRU may autonomously perform and control beam failure recovery procedures for MIMO. The WTRU may be configured and enabled with a feature of autonomous WTRU-controlled beam failure recovery for MIMO. The WTRU may perform one or more of the following steps. The WTRU may monitor BFD-RS for MIMO. The WTRU may measure primary NBI-RS resources. The WTRU may transmit BFRQ with NBI selected from the primary NBI-RS resource set. If beam/channel quality deteriorates (e.g., measurement such as L1-RSRP, L1-SINR is below a (pre-)configured threshold), the WTRU may autonomously switch to a secondary NBI-RS resource set. The WTRU may continue the beam failure recovery procedure and measure secondary NBI-RS resources. The WTRU may transmit a BFRQ with an NBI selected from secondary NBI-RS resource set. The WTRU may receive DCI in a PDCCH for the response from base stations/TRPs. The WTRU may complete beam failure recovery procedure for MIMO.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer. Although features and elements are described for massively-distributed MIMO, they may also be applicable to cell-free MIMO or user-centric MIMO.

1. A method for beam failure recovery in a system utilizing a multiple input-multiple output (MIMO) antenna scheme, the method comprising:
receiving configuration information comprising beam failure recovery parameters, the beam failure recovery parameters comprising:
information indicating a number of resources of a first beam failure detection (BFD) reference signal (RS) resource set to be monitored; and
priority information associated with each of the resources of the first BFD-RS resource set;
monitoring the indicated number of resources of the first BFD-RS resource set based on the priority information associated with each of the resources, wherein monitoring the indicated number of resources of the first BFD-RS resource set comprises:
measuring, using a first measurement periodicity, a first signal quality metric for a first subset of resources of the first BFD-RS resource set; and
measuring, using a second measurement periodicity, a second signal quality metric for a second subset of resources of the first BFD-RS resource set;
transmitting a message to obtain a second BFD-RS resource set, the message including an index associated with one of the resources of the first BFD-RS resource set;
receiving reconfiguration information indicating the second BFD-RS resource set, wherein the second BFD-RS resource set includes resources selected based on the one of the resources of the first BFD-resource set;
transmitting at least a first beam failure recovery request message (BFRQ) to perform beam failure recovery using one of the resources of the second BFD-RS resource set; and
receiving a response to the at least the first BFRQ indicating that beam failure recovery procedure is complete.

2. The method of claim 1, wherein the response to the at least the first BFRQ includes downlink control information (DCI) including information confirming the first BFRQ to perform beam failure recovery using the one of the resources of the second BFD-RS resource set.

3. The method of claim 1, wherein the response to the at least the first BFRQ includes downlink control information (DCI) including information overriding the first BFRQ to perform beam failure recovery using the one of the resources of the second BFD-RS resource set, wherein the DCI further indicates a different resource to be used for beam failure recovery.

4. The method of claim 1, the response to the at least the first BFRQ includes downlink control information (DCI) including information indicating to transmit a second BFRQ, wherein the method further comprises transmitting the second BFRQ and receiving DCI responsive to the second BFRQ, and wherein the DCI responsive to the second BFRQ includes one of information confirming or overriding the second BFRQ.

5. The method of claim 1, wherein the beam failure recovery parameters include information indicating whether to include assistance information when transmitting a BFRQ; wherein the assistance information includes one or more of: a new beam identifier (NBI), a signal quality measurement associated with the new beam identifier, or a difference between a signal quality measurement associated with a new beam identifier and a threshold value.

6. The method of claim 5, wherein the NBI identifies one of a beam associated with a highest signal quality measurement or a beam having a signal quality metric that exceeds the threshold value.

7. The method of claim 5, wherein the assistance information is transmitted using resources associated with a physical random access channel (PRACH) occasion, a random access channel (RACH) occasion, or a physical uplink control channel (PUCCH), a medium access control element (MAC CE).

8. The method of claim 1, wherein the message to obtain the second BFD-RS resource set is one of a BFRQ, a beam switch request (BSR), a beam switch recommendation, or a beam switch order.

9. The method of claim 1, wherein the message transmitted to obtain the second BFD-RS resource set includes an indication of a transmission configuration indication (TCI) state, and wherein the reconfiguration information is received using parameters based on the indicated TCI state.

10. The method of claim 1, wherein the first signal quality metric is a layer 1 (L1) signal to interference plus noise ratio (SINR), and wherein the second signal quality metric is an L1-reference signal receive power (RSRP).

11. A wireless transmit/receive unit (WTRU) configured to perform beam failure recovery in a system utilizing a multiple input-multiple output (MIMO) scheme, the WTRU comprising:
a processor; and
a transceiver;
the processor and the transceiver configured to receive configuration information comprising beam failure recovery parameters, the beam failure recovery parameters comprising:
information indicating a number of resources of a first beam failure detection (BFD) reference signal (RS) resource set to be monitored; and
priority information associated with each of the resources of the first BFD-RS resource set;
the processor and the transceiver configured to monitor the indicated number of resources of the first BFD-RS resource set based on the priority information associated with each of the resources, wherein monitoring the indicated number of resources of the first BFD-RS resource set comprises:
the processor and the transceiver configured to measure, using a first measurement periodicity, a first signal quality metric for a first subset of resources of the first BFD-RS resource set; and
the processor and the transceiver configured to measure, using a second measurement periodicity, a second signal quality metric for a second subset of resources of the first BFD-RS resource set;
the processor and the transceiver configured to transmit a message to obtain a second BFD-RS resource set, the message including an index associated with one of the resources of the first BFD-RS resource set;
the processor and the transceiver configured to receive reconfiguration information indicating the second BFD-RS resource set, wherein the second BFD-RS resource set includes resources selected based on the one of the resources of the first BFD-resource set;
the processor and the transceiver configured to transmit at least a first beam failure recovery request message (BFRQ) to perform beam failure recovery using one of the resources of the second BFD-RS resource set; and
the processor and the transceiver configured to receive a response to the at least the first BFRQ indicating that beam failure recovery procedure is complete.

12. The WTRU of claim 11, wherein the response to the at least the first BFRQ includes downlink control information (DCI) including information confirming the first BFRQ to perform beam failure recovery using the one of the resources of the second BFD-RS resource set.

13. The WTRU of claim 11, wherein the response to the at least the first BFRQ includes downlink control information (DCI) including information overriding the first BFRQ to perform beam failure recovery using the one of the resources of the second BFD-RS resource set, wherein the DCI further indicates a different resource to be used for beam failure recovery.

14. The WTRU of claim 11, wherein the response to the at least the first BFRQ includes downlink control information (DCI) including information indicating to transmit a second BFRQ, wherein the processor and the transceiver are further configured to transmit the second BFRQ and receiving DCI responsive to the second BFRQ, and wherein the DCI responsive to the second BFRQ includes one of information confirming or overriding the second BFRQ.

15. The WTRU of claim 11, wherein the beam failure recovery parameters include information indicating whether to include assistance information when transmitting a BFRQ; wherein the assistance information includes one or more of: a new beam identifier (NBI), a signal quality measurement associated with the new beam identifier, or a difference between a signal quality measurement associated with a new beam identifier and a threshold value.

16. The WTRU of claim 15, wherein the NBI identifies one of a beam associated with a highest signal quality measurement or a beam having a signal quality metric that exceeds the threshold value.

17. The WTRU of claim 15, wherein the assistance information is transmitted using resources associated with a physical random access channel (PRACH) occasion, a random access channel (RACH) occasion, or a physical uplink control channel (PUCCH), a medium access control element (MAC CE).

18. The WTRU of claim 11, wherein the message to obtain the second BFD-RS resource set is one of a BFRQ, a beam switch request (BSR), a beam switch recommendation, or a beam switch order.

19. The WTRU of claim 11, wherein the message transmitted to obtain the second BFD-RS resource set includes an indication of a transmission configuration indication (TCI) state, and wherein the reconfiguration information is received using parameters based on the indicated TCI state.

20. The WTRU of claim 11, wherein the first signal quality metric is a layer 1 (L1) signal to interference plus noise ratio (SINR), and wherein the second signal quality metric is an L1-reference signal receive power (RSRP).
